(19) United States
(12) Patent Application Publication
(10) Pub. No.: US 2025/0073869 A1
(43) Pub. Date: Mar. 6, 2025

(54) TORQUE WRENCH SPANNER ADAPTER SYSTEM AND METHOD

(71) Applicant: Dustin Martin, San Jose, CA (US)

(72) Inventor: Dustin Martin, San Jose, CA (US)

(21) Appl. No.: 18/822,228

(22) Filed: Sep. 1, 2024

Related U.S. Application Data
(60) Provisional application No. 63/580,420, filed on Sep. 4, 2023.

(51) Int. Cl. B25B 23/142

(52) U.S. Cl. CPC B25B 23/1427

(57) ABSTRACT

Many fasteners need to be tightened or “torqued” to precise values, and adjustable torque wrenches are used for this purpose. Unfortunately, many fasteners don't have torque wrench-compatible sockets and thus require torque wrench adapters. These adapters introduce torque offsets, leading to inaccurate torque settings. Here, an improved adapter system is taught, which can be used with ER collet nuts and other popular nuts. In addition to mechanical improvements, the adapters may be marked with computer-readable markings. A smartphone system reads these markings and can either directly or using an internet server, recommend optimal torque conversion settings for a given fastener, adapter, and torque wrench combination.

### CROSS-REFERENCE TO RELATED APPLICATIONS

This application claims the priority benefit of U.S. provisional patent application 63/580,420, filed Sep. 4, 2023, the entire contents of which are incorporated herein by reference.

### BACKGROUND OF THE INVENTION

### Field of the Invention

This invention is in the field of torque wrenches and torque wrench adapters.

### Description of the Related Art

Torque wrenches are tools that tighten a fastener to a specific torque value. These are usually used with different sockets that enable them to accommodate the different shapes and sizes of various fasteners. However, some fasteners do not have corresponding sockets and require specialized adaptors to be torqued properly. Adaptors introduce offsets at the pivot point of the driver end of a torque wrench. This results in a higher actual torque value than originally specified on the wrench. This discrepancy causes parts to be torqued out of specification.

To accommodate this problem, according to the prior art, manufacturers often recommend a max torque or a constant torque multiplier be applied when using an adapter.

### BRIEF SUMMARY OF THE INVENTION

The invention is based partly on the insight that nearly every torque wrench setup is different. As a result, the prior art practice of using constant torque multipliers is inaccurate. It only approximates the torque value applied when an adapter is used.

As disclosed herein, the invention can comprise at least one (and often a series of) torque wrench adaptors and accompanying software. The adaptors can torque down fasteners that do not conform to a socket. The invention's software enables users to quickly select their torque wrench and application to get the correct torque settings for their setup.

In some embodiments, additional calibration methods may also be used. For example, a calibration bar or nut may connect the adaptors to a torque meter to facilitate an extra layer of confirmation about the torque value applied to the fastener.

To get an accurate torque value, it is required to have the correct torque multiplier for a given setup. To do this, the invention's torque wrench adaptor system pairs the adaptor with an application that allows users to select the correct torque settings for a particular setup. In some circumstances, the software will collect additional information to calculate the correct torque value; for example, in the case of the pin spanner adaptor, it is necessary to collect the diameter of the part being torqued down because the diameter impacts the distance between centers.

In some embodiments, the software may only rely on a library of collected information to reliably recommend torque settings for a given setup. However, individual torque wrenches are not always accurate. Thus, in some embodiments, a calibration method may also be a part of this system. The user may use a calibration bar or nut to attach the adapter to a torque-measuring device. This torque measuring device may be configured to calibrate or verify a torque wrench. This way, the user can calibrate the software to ensure the amount of torque delivered is accurate.

### BRIEF DESCRIPTION OF THE DRAWINGS

FIG. 1 shows an example of the invention's torque wrench spanner adapter (100) attaching to a spanner nut (such as a notched collet nut (160) via spanner nut notches and corresponding pins (108) on the distal end (102) of the adapter).

FIG. 2 shows a close-up of the torque wrench spanner adapter, showing a clearer view of the distal end pull tab (110).

FIG. 3 shows an alternate view of the torque wrench spanner adapter (100) and the torque wrench (140), showing the torque wrench's distal drive (142), arm (144), and proximal handle (146).

FIG. 4A shows how the distal end pull tab (110) can help the user's fingers apply and remove the adapter's driver socket from the socket wrench's distal drive.

FIG. 4B shows an alternative embodiment in which the distal end of the adapter is configured as a crescent wrench.

FIG. 5A shows how the adapter may be marked to facilitate using a computerized device to determine the torque relationship. Here an optical QR code type mark (112) is shown.

FIG. 5B shows using a camera-equipped computerized device, such as a smartphone or tablet computer (200), to scan the mark (112)

FIG. 6 shows how the computerized device (200) can scan the mark (112), and transmit at least some information encoded in the mark over the internet (210) to a remote server (212), which can then retrieve torque conversion information (e.g., the relevant torque relationship), and in turn, transmit this back to the computerized device (200).

FIG. 7 shows an example of the type of data that the remote internet server (212) may transmit to the computerized device (200).

FIG. 8 shows a flow chart showing how the computerized device and server software can manage a plurality of torque wrenches and adapters.

FIG. 9A shows an example of a calibration nut (300) that may be used with an ER32 collet system and a torque meter to help calibrate the adapter system.

FIG. 9B shows an example of a calibration bar (320) that may be used with the system.

FIG. 9C shows how the calibration nut from FIG. 9A (300) can be used with a torque meter (310) to calibrate the adapter system.

FIG. 10 shows an embodiment configured to torque other types of fasteners to a given specification without the need of calculation to determine the torque offset manually.

FIG. 11A shows a 3D view of an alternate adapter configuration for a 12-point box end socket previously shown in FIG. 10.

FIG. 11B shows another 3D view of the alternate adapter configuration previously shown in FIG. 11A.

FIG. 12A shows a first view of a box wrench adapter for a 2.25-inch fastener.

FIG. 12B shows a second view of the box wrench adapter for a 2.25-inch fastener.

FIG. 12C shows a third view of the box wrench adapter for a 2.25-inch fastener.

### DETAILED DESCRIPTION OF THE INVENTION

In some embodiments, the invention may be a method of configuring at least one adjustable torque wrench (140) and at least one torque wrench spanner adapter (100) to apply a predetermined amount of torque to at least one spanner nut (160).

The invention uses at least one adjustable torque wrench (140). This torque wrench will often comprise comprising a distal drive (142), and in some embodiments may also comprise an arm (144), and proximal handle (146) as well.

The invention also uses at least one torque wrench spanner adapter (100). This torque wrench spanner adapter will typically comprise comprising a distal end (102) configured to attach to at least one spanner nut (160). The adapter will also comprise a proximal end (104) with a driver socket (106) that is configured to attach to the distal drive (142).

The torque wrench spanner adapter (100) will have a spanner nut axis of rotation (170) that is displaced from an axis of rotation of the driver socket (120). This arrangement alters the torque relationship between the driver-torque applied to the driver socket (122) and the spanner-nut-torque (172) applied to the spanner nut (160).

Although the adapter may be marked directly with one or more torque conversion factors in human-readable form (e.g., using text and numbers), such preset factors often do not provide enough flexibility. Thus, in a preferred embodiment, the adapter is marked with a computer-readable mark. Here the user may use various types of computerized devices (200), such as smartphones, to read the mark. The computerized device can then be used to determine the torque relationship. The user can then adjust the adjustable torque wrench (140) to apply torque to the adapter according to this torque relationship.

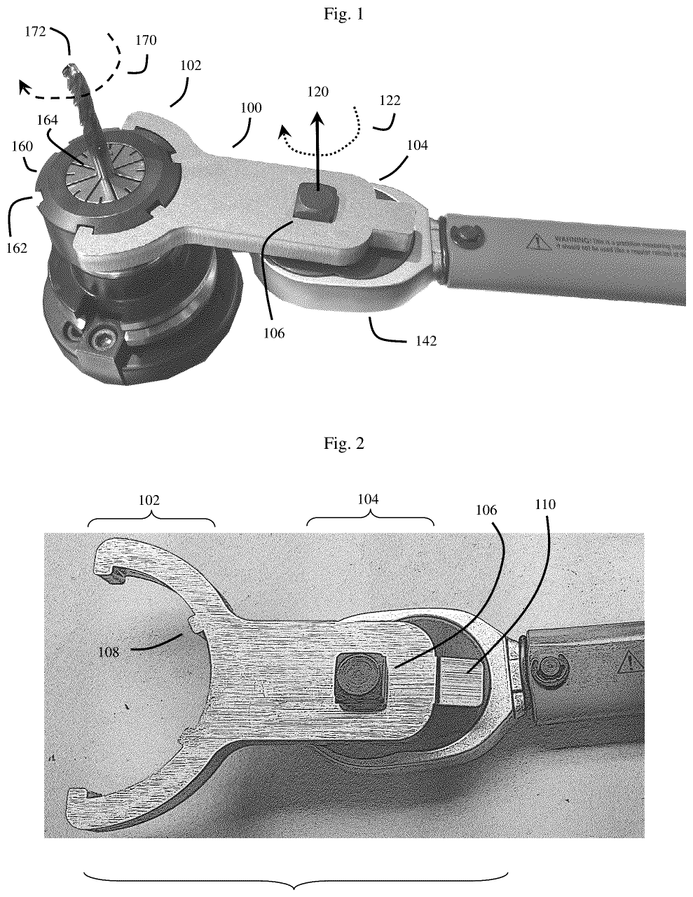

FIG. 1 shows an example of the invention's torque wrench spanner adapter (100) attaching to a spanner nut (such as a notched collet nut (160) via spanner nut notches (162) and corresponding pins (108) on the distal end (102) of the adapter). The proximal end of the adapter (104) has a driver socket (106) that attaches to the distal drive end (142) of a torque wrench (140). Note that the collet nut (spanner nut (160)) and collet (164) have a spanner nut axis of rotation (170), represented by the attached drill bit (172). At the same time, the distal drive of the torque wrench is applying torque to a different axis of rotation (120) along the adapter's driver socket (106), located on the proximal end (104) of the adapter (100). Thus, the axis of rotation of the spanner nut (170, 172) is displaced from the axis of rotation of the adapter's driver socket (120, 122). As a result, if the torque wrench applies a given amount of torque (122) to the adapter's driver socket (106), a different amount of torque will be applied to the spanner nut axis of rotation (170, 172).

FIG. 2 shows a close-up of the torque wrench spanner adapter (100), showing a clearer view of the distal end pull tab (110).

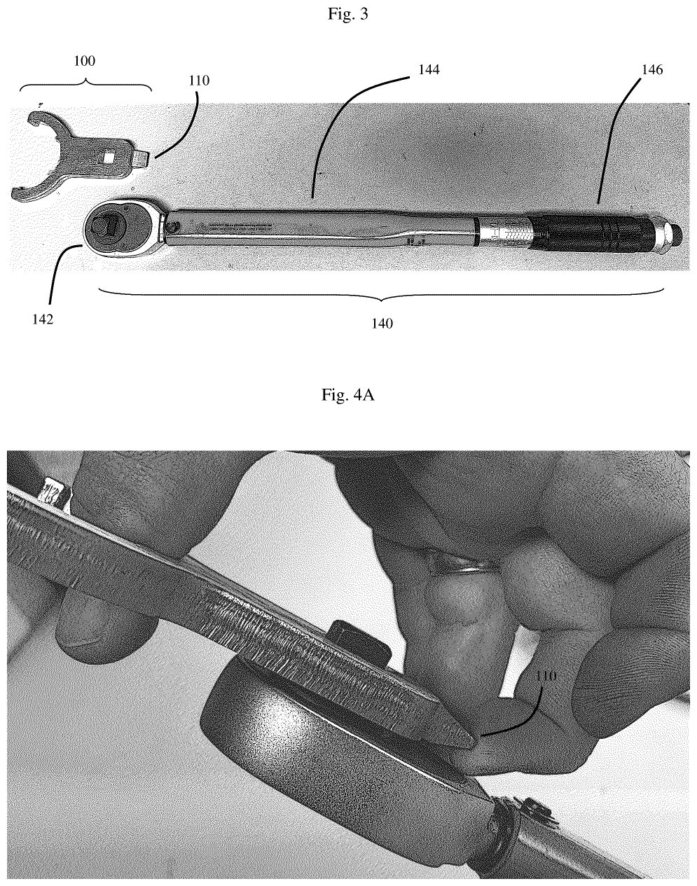

FIG. 3 shows an alternate view of the torque wrench spanner adapter (100) and the torque wrench (140), showing the torque wrench's distal drive (142), arm (144), and proximal handle (146). The adapter's distal end pull tab (110) is also shown.

Note that the spanner nut may comprise a collet nut in some embodiments. Most examples and figures shown herein are based on collet nuts, such as ER collet nuts.

In some embodiments, the torque wrench spanner adapter may comprise a distal end pull tab (110). This distal end pull tab enables a user's fingers to remove the driver socket from the distal drive.

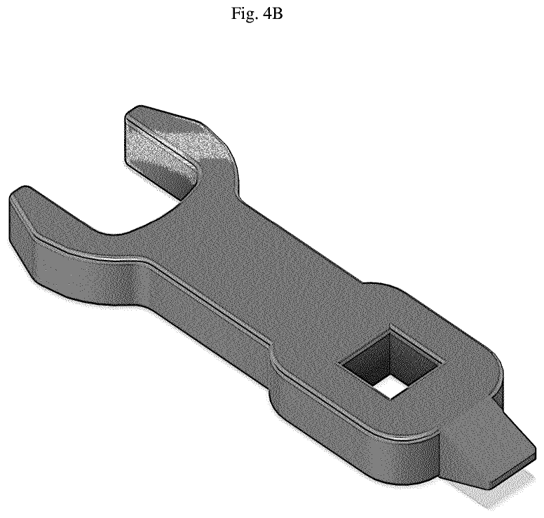

FIG. 4A shows how the distal end pull tab (110) can help the user's fingers apply and remove the adapter's driver socket from the socket wrench's distal drive.

Note that the torque wrench spanner adapter may further comprise a crescent wrench adapter in some embodiments.

FIG. 4B shows an alternative embodiment in which the distal end of the adapter is configured as a crescent wrench.

In some embodiments, the mark may be computer-readable, such as a bar code or QR code (112). In these embodiments, the computerized device (200) usually comprises a camera, a computer processor, and an optional internet connection (210). In some embodiments, determining the torque relationship comprises using the camera and processor to image the mark (112). The device's processor may then use an internet connection (210) to retrieve the torque relationship from a remote internet server (212). Alternatively, the device may have tables or equations for determining the torque relationship already stored in memory, in which case the torque relationship may be presented without the need for an internet connection.

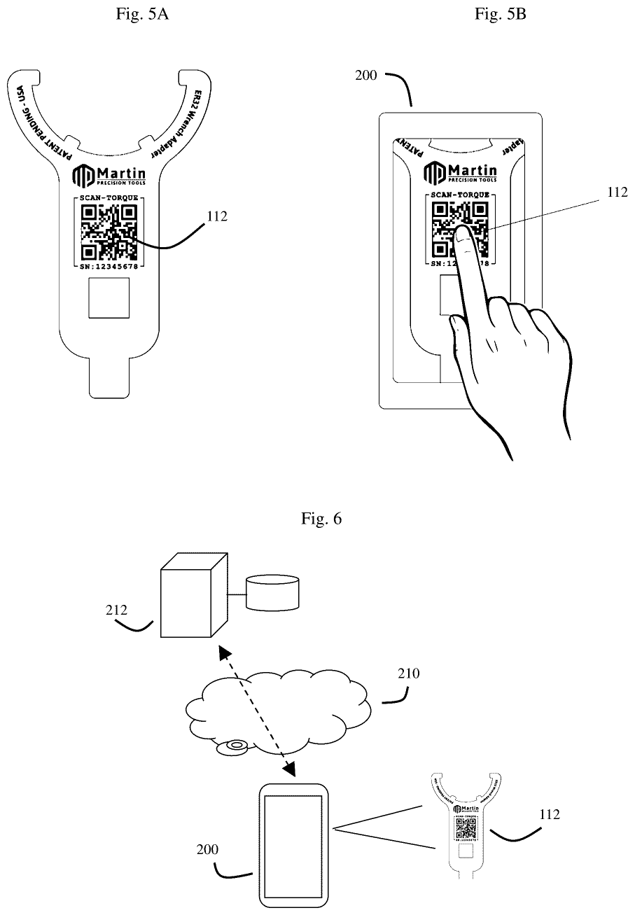

FIG. 5A shows how the adapter may be marked to facilitate using a computerized device to determine the torque relationship. Here an optical QR code type mark (112) is shown.

FIG. 5B shows using a camera-equipped computerized device, such as a smartphone or tablet computer (200), to scan the mark (112)

FIG. 6 shows how the computerized device (200) can scan the mark (112), and transmit at least some information encoded in the mark over the internet (210) to a remote server (212). In this embodiment, the remote server can then retrieve the torque conversion information (e.g., the relevant torque relationship), and, in turn, transmit this back to the computerized device (200).

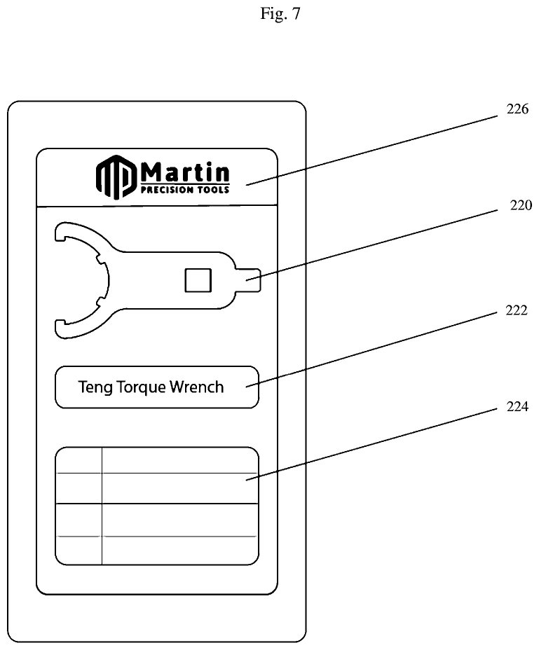

FIG. 7 shows an example of the data type that the remote internet server (212) may transmit to the computerized device (200). This data may include a confirmatory image of the adapter (220), the adapter's name (222), and one or more torque relationships (224). Sometimes, the server may transmit a table of torque relationships for various possible torque wrenches and spanner nut configurations. Software identification data may also be transmitted (226. Again, in alternative embodiments, this information may be stored in the computerized device memory, and the same results may be obtained without the need of the internet connection or remote server.

In some embodiments, at least one torque wrench spanner adapter may comprise a plurality of torque wrench spanner adapters. Here, at least some of these various torque wrench spanner adapters may comprise torque wrench spanner adapters with different displacements and torque relationships. According to the invention, these different spanner adapters with different displacements and torque relationships are given different marks.

Further, in some embodiments, this plurality of torque wrench spanner adapters may be stored in assigned locations according to any of the properties of their corresponding spanner nuts and/or their different torque relationships.

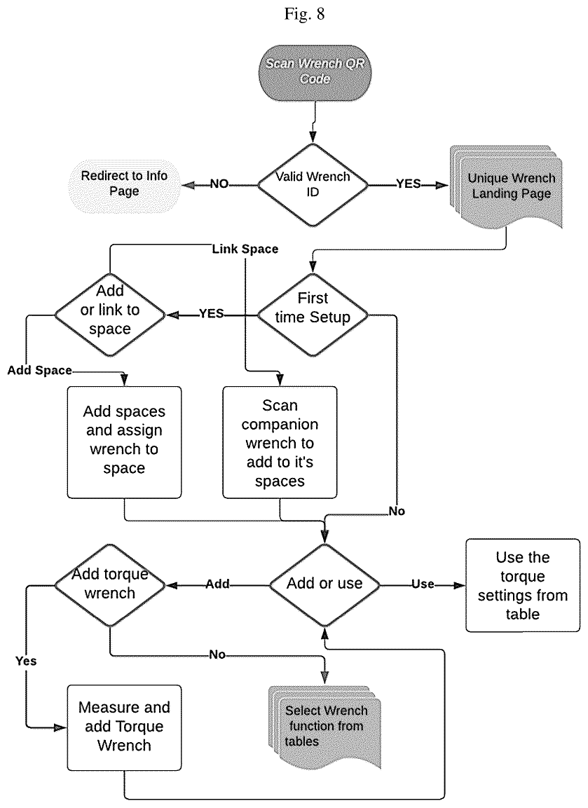

FIG. 8 shows a flow chart showing how the computerized device and server software can manage a plurality of torque wrenches and adapters.

### Additional Discussion

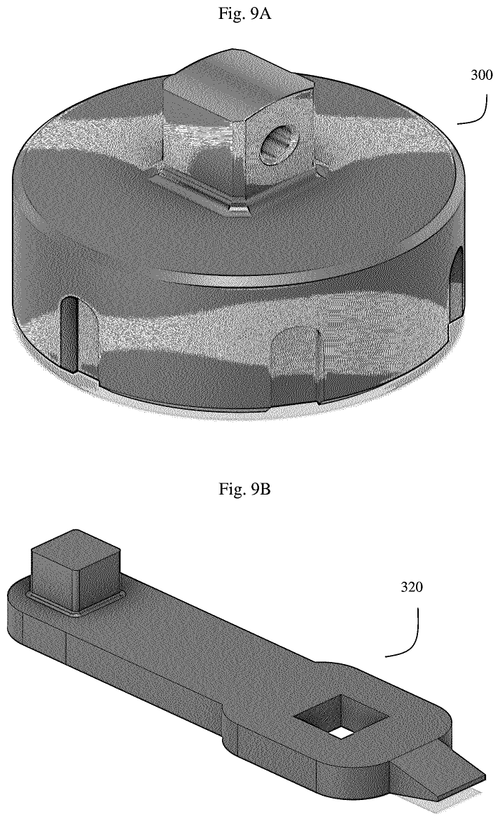

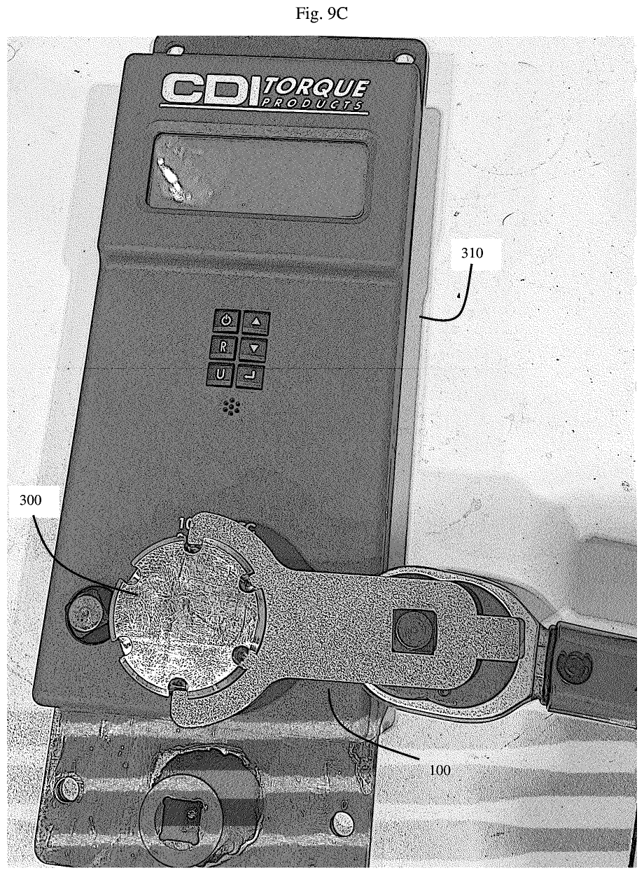

Torque wrenches were never designed to have adaptors attached, so it can be challenging to use an adaptor. Torque wrenches will not lock the ratchet lug or provide clearance behind it so you can grab it. For those reasons, the adapter may optionally have additional features. These additional features can include any of the following:
A spin stop, which will prevent the torque wrench adaptor from spinning by having a leg that attaches to the side of the wrench
A pull tab that allows the user to get their finger under the adaptor to pull it vertically off the wrench. Otherwise, it is difficult to remove the adaptor from the torque wrench.
   Working with a Series or Collection of Torque Wrench Adapters
There can be multiple different types of wrenches that can exist in a given series. These include spanner wrenches, ER Collet wrenches, pin spanners, crescent wrenches, and adjustable wrenches.
Each wrench series defines a constant distance between the two critical midpoints. The adaptor's connection points to the torque wrench, and the adaptor's connection to what it was adapted for.
In a preferred embodiment, this distance stays constant within a series so that a single testing device can accurately validate the torque settings for the entire series within a series. In this case, the supported testing devices are:
   Calibration bar (see FIG. 9B), a bar with male-female square lugs with the distance between centers being the same for that series.
   Calibration Nut (see FIGS. 9A and 9C), a nut with a receiving end that mates to a given torque wrench adaptor and a square lug on its center to interface with the calibration device.

FIG. 9A shows an example of a calibration nut (300) that may be used with an ER32 collet system and a torque meter to help calibrate the adapter system.

FIG. 9B shows an example of a calibration bar (320) that may be used with the system.

FIG. 9C shows how the calibration nut from FIG. 9A (300) can calibrate the adapter system with a torque meter (310).
In some embodiments, the system can use a computerized device and a custom application (app) that can be accessed after scanning a QR code on the wrench. This allows the users to select the correct torque settings for their application using their torque wrench.
As previously discussed, the pull tab (110) can form part of the back of the adaptor (100) so the user can grab the adaptor from both the front and back to uniformly pull on the device. Otherwise, the adaptor will bind when being pulled at one end due to the angle.
Spin lock: The adaptors tend to spin when torque wrenches have two-way ratches. The spin lock is a leg that attaches to the adaptor so that the adaptor binds if keeps traveling in the non-locking direction.
As previously discussed, in some embodiments, each wrench may be identified by a serial number encoded into a QR code on the wrench.
When the QR code is scanned, an app will be presented to the user. As an example, this software app may use various types of algorithms, such as exemplified by the software flow chart shown in FIG. 8.
In some embodiments, wrenches can be linked together so that if the QR code is damaged on one wrench, an adjacent wrench can be scanned and used to quickly select the current wrench in hand.
In some embodiments, the (software) app can present a table of torque settings customized to this particular wrench.
   In the case of an ER-style wrench, a table of ER collet sizes with recommended torque values can be provided.
In some embodiments, the software app can support a hierarchy space division structure and allows a wrench to be assigned to it. The top-level node may be configurable, and each node below may also be configurable. Here are some examples of what this structure could look like:
   Shop→Tool Crib→Station A.
   Garage→Bay→ToolChest
   Business Name→VM2-A
   Bobs Garage

### Alternate Embodiments

It should be emphasized that although adapters for collet nuts have been used as a particular example, adapters for other types of nuts are also contemplated and claimed.

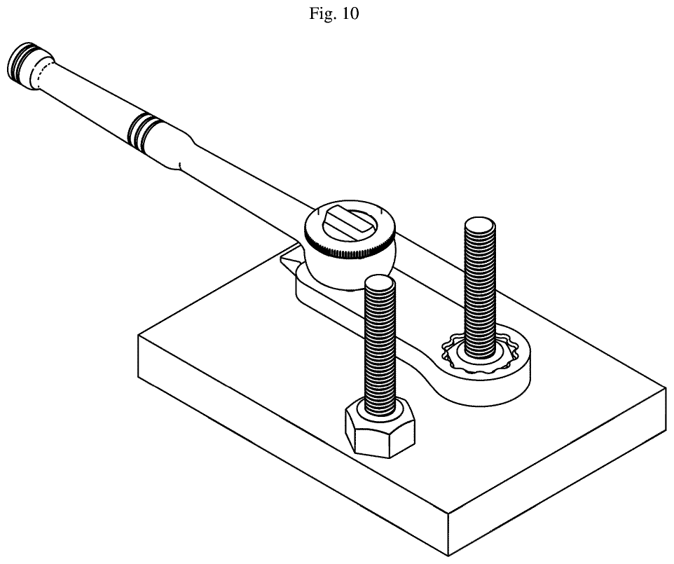

FIG. 10 shows an embodiment configured to torque a different type fastener, such as a 12-point box end nut, to a given specification without the need of calculation to determine the torque offset manually.

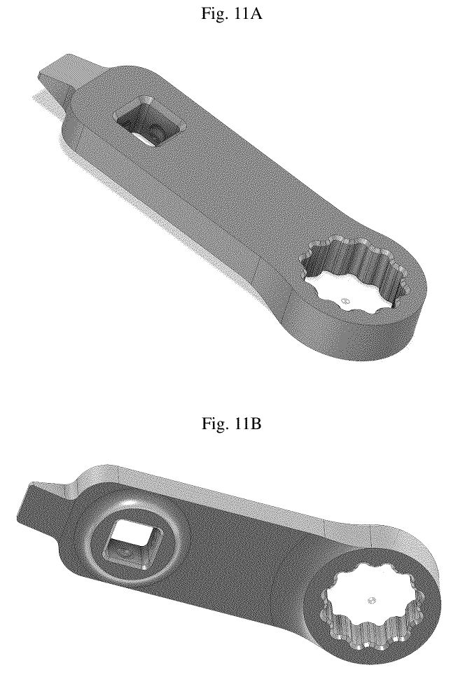

FIG. 11A shows a 3D view of an alternate adapter configuration for a 12-point box end nut previously shown in FIG. 10.

FIG. 11B shows another 3D view of the alternate adapter configuration previously shown in FIG. 11A.

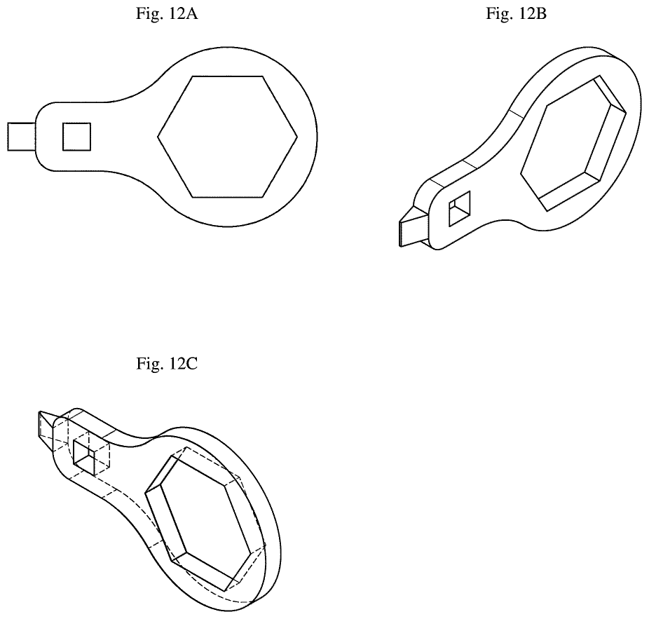

FIG. 12A shows a first view of a box wrench adapter configured for a 2.25-inch hexagonal fastener.

FIG. 12B shows a second view of the box wrench adapter configured for a 2.25-inch hexagonal fastener.

FIG. 12C shows a third view of the box wrench adapter configured for a 2.25-inch hexagonal fastener.

1. A method of configuring at least one adjustable torque wrench and at least one torque wrench spanner adapter to apply a predetermined amount of torque to at least one spanner nut, said method comprising:
obtaining at least one adjustable torque wrench comprising a distal drive, arm, and proximal handle;
obtaining at least one torque wrench spanner adapter, said torque wrench spanner adapter comprising a distal end configured to attach to at least one said spanner nut, and a proximal end comprising a driver socket configured to attach to said distal drive;
said torque wrench spanner adapter having a spanner nut axis of rotation that is displaced from an axis of rotation of said driver socket, thus altering a torque relationship between driver-torque applied to said driver socket and spanner-nut-torque applied to said spanner nut;
marking said torque wrench spanner adapter, and using at least one computerized device and said mark to determine said torque relationship, and
adjusting said adjustable torque wrench to apply torque according to said torque relationship.

2. The method of claim 1, wherein said at least one torque wrench spanner adapter further comprises a distal end pull tab, said distal end pull tab configured to enable a user's fingers to remove said driver socket from said distal drive.

3. The method of claim 1, wherein said mark is any of a bar code or QR code, and said computerized device further comprises a camera, computer processor and an internet connection;
wherein determining said torque relationship comprises using said camera and processor to image said mark and using said processor and said internet connection to retrieve said torque relationship from a remote internet server.

4. The method of claim 1, wherein said at least one torque wrench spanner adapter comprises a plurality of torque wrench spanner adapters;
at least some of said plurality of torque wrench spanner adapters comprise torque wrench spanner adapters with different displacements and different torque relationships; and
further marking those spanner adapters with different displacements and different torque relationships with different marks.

5. The method of claim 4, further storing said plurality of torque wrench spanner adapters in assigned locations according to any of the properties of their corresponding spanner nuts and/or their different torque relationships.

6. The method of claim 1, wherein said torque wrench spanner adapter further comprises a crescent wrench adapter.

7. The method of claim 1, wherein said spanner nut further comprises a collet nut.

8. The method of claim 1, further using any of a calibration bar, calibration nut, and torque meter to calibrate said adapter and/or determining said torque-relationship.
